(19) United States
(12) Patent Application Publication
(10) Pub. No.: US 2024/0385726 A1
(43) Pub. Date: Nov. 21, 2024

(54) APPARATUS, METHOD, AND COMPUTER READABLE STORAGE MEDIUM

(71) Applicant: CANON KABUSHIKI KAISHA, Tokyo (JP)

(72) Inventor: AKIHIRO YASUDA, Saitama (JP)

(21) Appl. No.: 18/652,605

(22) Filed: May 1, 2024

(30) Foreign Application Priority Data
May 17, 2023 (JP) 2023-081355

(51) Int. Cl. G06F 3/04817; G06F 3/12

(52) U.S. Cl. CPC G06F 3/04817; G06F 3/1204; G06F 3/1253; G06F 3/1285

(57) ABSTRACT

An apparatus to perform acquiring for acquiring an icon image of a first printer based on identification information acquired from the first printer, acquiring an icon image of a second printer based on identification information for the second printer acquired from a server, and controlling a display unit to display the acquired icon images of the first and the second printers.

### BACKGROUND

### Technical Field

The aspect of the embodiments relates to an information processing apparatus, a method for controlling the information processing apparatus and a computer readable storage medium.

### Description of the Related Art

Conventionally, printing has been performed by drivers provided by printer vendors (printer manufacturers). In recent years, the use of standard drivers provided by an operating system (OS) manufacturer makes it possible to perform printing without using drivers provided by printer vendors. For example, Windows® is mounted with standard drivers called Internet Printing Protocol (IPP) class drivers. Android® is mounted with standard drivers called Mopria®. iOS® is mounted with standard drivers called AirPrint® as a function of the OS. These standard drivers transmit print commands conforming to a printing protocol called IPP. Accordingly, printers supporting IPP can receive relevant print commands and perform printing. These standard drivers are characterized in the ability to enable a plurality of printer models from a plurality of printer vendors conforming to a printing protocol to perform printing. More specifically, the standard drivers are compatible with a plurality of printer models.

Japanese Patent Application Laid-Open No. 2022-89143 discusses a technique in which a driver installed in an information processing apparatus communicable with a printer acquires icon image data representing the outer appearance of the printer from the printer. The driver provides the OS with the icon image data, enabling the OS to display icons on a printer management screen (e.g., device and printer screen) provided by the OS.

The OS is assumed to provide a plurality of types of standard printer drivers. For example, the OS may provide both a printer driver for generating print data to be directly transmitted to a printer connected to the same network as the information processing apparatus, and a printer driver for generating print data to be transmitted to a printer via a cloud print service. In this case, if the OS displays the same icon image when using whichever printer driver, a user finds it difficult to distinguish between the directly connected printer and the printer connected via the cloud print service.

### SUMMARY

According to an aspect of the embodiments, an apparatus to perform acquiring an icon image of a first printer based on identification information acquired from the first printer, acquiring an icon image of a second printer based on identification information for the second printer acquired from a server, and controlling a display unit to display the acquired icon images of the first and the second printers.

Further features of the disclosure will become apparent from the following description of exemplary embodiments with reference to the attached drawings.

### BRIEF DESCRIPTION OF THE DRAWINGS

FIG. 1 illustrates an example of a network configuration according to an exemplary embodiment.

FIGS. 2A to 2E illustrate examples of hardware configurations according to the present exemplary embodiment.

FIGS. 3A and 3B are sequence diagrams illustrating a sequence from installation of an extension application up to arrangement of an icon image according to the present exemplary embodiment.

FIG. 4 illustrates an example of a screen related to printers to be used, displayed by an operating system (OS) according to the present exemplary embodiment.

FIGS. 5A, 5B, and 5C illustrate examples of icon images according to the present exemplary embodiment.

FIGS. 6A, 6B1, 6B2, and 6B3 illustrate examples of information configuring device capability information according to the present exemplary embodiment.

FIGS. 7A and 7B illustrate examples of information configuring an extension setup information file according to the present exemplary embodiment.

FIG. 8 illustrates an example of a user interface (UI) where icon images are displayed for each queue by a print setting extension application according to the present exemplary embodiment.

FIG. 9 is a flowchart illustrating an example of icon image acquisition by the print setting extension application according to the present exemplary embodiment.

FIG. 10 is a flowchart illustrating another example of icon image acquisition by the print setting extension application according to the present exemplary embodiment.

FIG. 11 illustrates an example of a path of an icon image held by the OS according to the present exemplary embodiment.

FIG. 12 illustrates an example of a file system managed by an online support service according to the present exemplary embodiment.

FIG. 13 illustrates an example of a sequence performed when a printing apparatus and a client terminal are connected according to the present exemplary embodiment.

FIG. 14 schematically illustrates an example of print processing using the print setting extension application according to the present exemplary embodiment.

FIG. 15 illustrates an example of a print setting screen provided by a file generation application according to the present exemplary embodiment.

FIG. 16 illustrates an example of a print setting screen displayed by the print setting extension application according to the present exemplary embodiment.

### DESCRIPTION OF THE EMBODIMENTS

Exemplary embodiments of the disclosure will be described below with reference to the accompanying drawings.

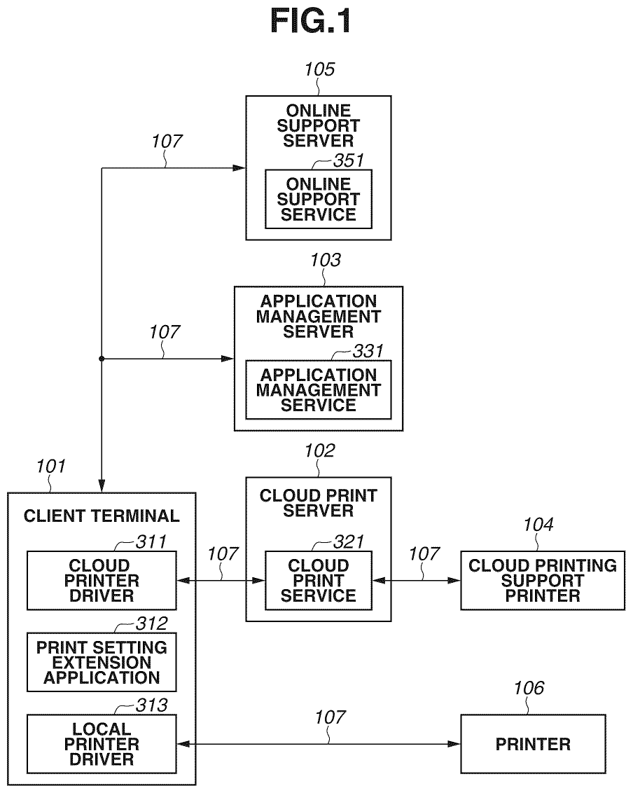

FIG. 1 schematically illustrates a printing system based on cloud printing according to a first exemplary embodiment. A client terminal 101, a cloud print server 102, an application management server 103, a cloud printing support printer 104, a printer 106, and an online support server 105 are connected with each other via a network 107.

While FIG. 1 illustrates one client terminal 101 and one cloud printing support printer 104, the printing system may include a plurality of the client terminals 101 and a plurality of the cloud printing support printers 104.

Each of the cloud print server 102, the application management server 103, and the online support server 105 may be a server system including a plurality of information processing apparatuses. Configuring each server as a server system including a plurality of information processing apparatuses enables the load to be distributed among the plurality of information processing apparatuses.

The cloud print server 102, the application management server 103, and the online support server 105 may be virtually configured in physically one information processing apparatus.

The network 107 for connection to cloud services is assumed to be a wide area network (WAN) such as the Internet. However, the network 107 may also be an entirely closed environment such as an in-house LAN.

The client terminal 101 is an information processing apparatus such as a personal computer (PC), tablet, and smartphone which are terminals directly operated by the user. Arbitrary application software can be executed on the client terminal 101.

The cloud printing support printer 104 is a device for actually performing printing on a recording medium such as sheets of paper. More specifically, the cloud printing support printer 104 is an image forming apparatus for converting print data received via the network 107 into image data and printing the image data. The printer 106 has a similar hardware configuration to the cloud printing support printer 104.

The printer 106 is communicably connected with the client terminal 101 without interposing a cloud print service 321. The client terminal 101 generates print data to be transmitted to the cloud printing support printer 104 via the cloud print service 321, by using a cloud printer driver 311. The client terminal 101 generates print data to be transmitted to the printer 106, by using a local printer driver 313.

The cloud printing support printer 104 may be able to receive and print the print data generated by the local printer driver 313, without interposing the cloud print service 321. The printer 106 may receive the print data generated by the cloud printer driver 311 via the cloud print service 321.

The cloud print server 102 receives a print instruction and print data from the outside. The cloud print server 102 transmits the received print data to the predetermined cloud printing support printer 104.

The application management server 103 stores and manages various applications.

The application management server 103 receives application identification information and a download request from the client terminal 101 and transmits the application identified by the received identification information to the client terminal 101.

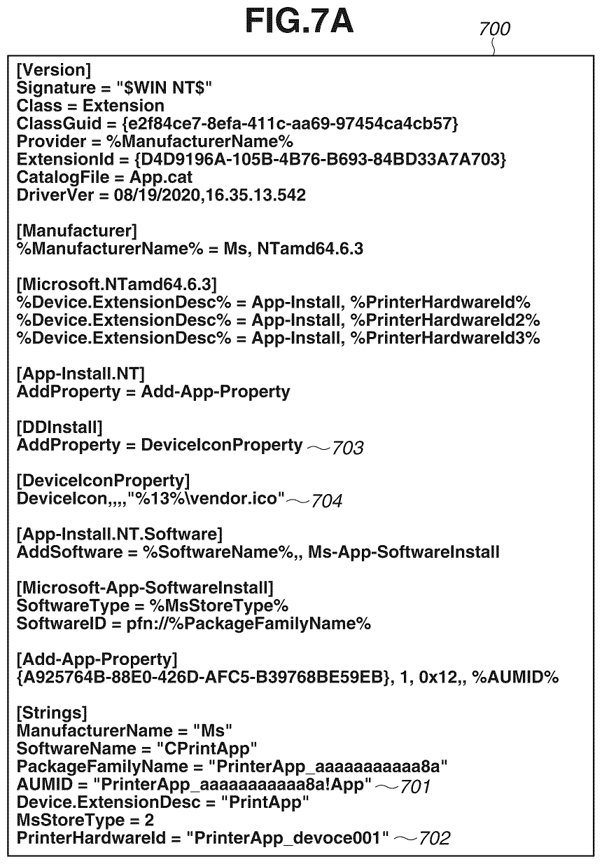

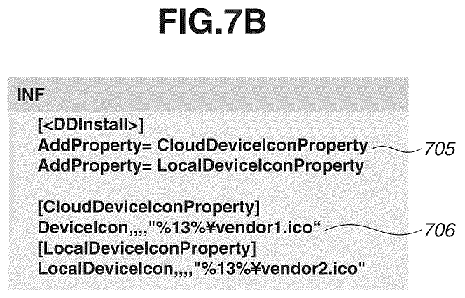

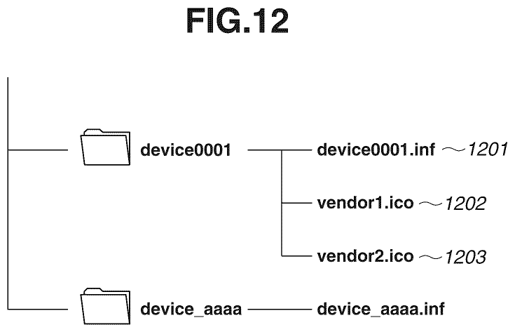

The online support server 105 is a server apparatus for providing the online support service 351 which is a server apparatus for providing the client terminal 101 with a file describing information for extending the function of the client terminal 101. A vendor (manufacture) providing the cloud printing support printer 104 and the printer 106 registers in advance information for extending the printing function provided by the operating system of the client terminal 101, to the online support service 351. FIG. 12 illustrates files 1201, 1202, and 1203 as an extension setup information file and icon images registered in the online support service 351 by a printer vendor. The file 1201 is an extension setup information file 700 illustrated in FIG. 7A. The files 1202 and 1203 indicate icon image data to be stored in association with print queue information when the client terminal 101 installs the extension setup information file 700.

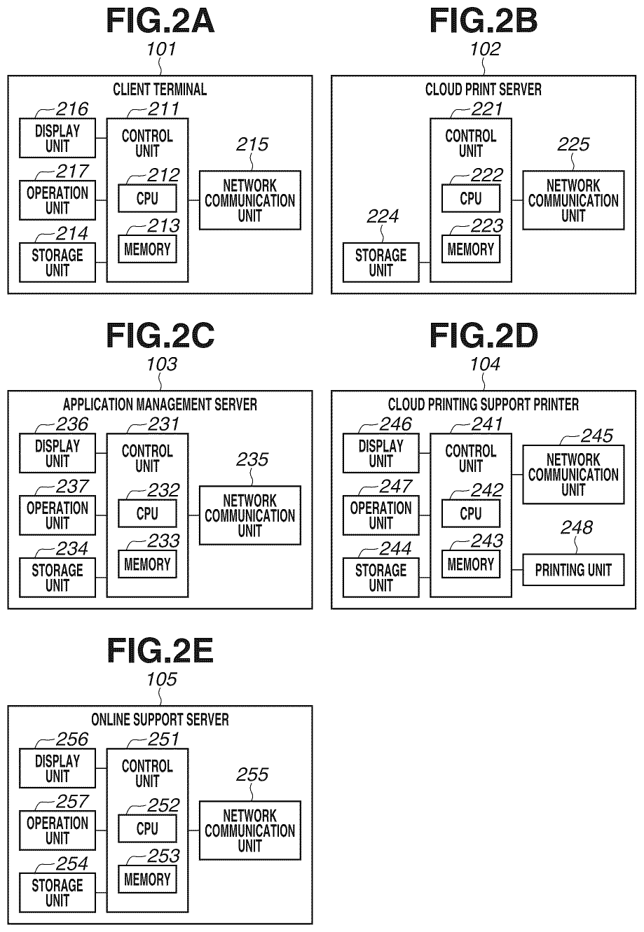

Hardware configurations in the printing system according to the present exemplary embodiment will be described below with reference to FIGS. 2A to 2E.

FIG. 2A is a block diagram illustrating an example of a hardware configuration of the client terminal 101.

The client terminal 101 includes a display unit 216, an operation unit 217, a storage unit 214, a control unit 211, and a network communication unit 215.

The storage unit 214 refers to a nonvolatile storage device such as a hard disk drive (HDD) and a solid state drive (SSD) capable of storing and rewriting digital data.

The control unit 211 including a central processing unit (CPU) 212 and a memory 213 controls the overall operation of the client terminal 101. The CPU 212 loads a program stored in the storage unit 214 into the memory 213 and executes the program. The memory 213 as the main memory of the CPU 212 is used as a working area and a temporary storage area for loading various programs.

The network communication unit 215 communicates with an external network 107 to input and output digital data from and to external servers and client terminals via the network 107.

The display unit 216 is an apparatus such as a liquid crystal display for displaying visual information to the user in real time. The operation unit 217 is an apparatus for receiving an input from the user via a keyboard and a mouse. The operation unit 217 may also be an apparatus having the functions of both the display unit 216 and the operation unit 217, such as a touch panel.

FIG. 2B is a block diagram illustrating an example of a hardware configuration of the cloud print server 102. The cloud print server 102 includes a storage unit 224, a control unit 221, and a network communication unit 225.

Descriptions of the storage unit 224, the control unit 221, and the network communication unit 225 are the same as the descriptions of the client terminal 101, and redundant descriptions thereof will be emitted.

The cloud print server 102 will be described below as an information processing apparatus having the hardware configuration illustrated in FIG. 2B. However, the cloud print server 102 may be configured as a plurality of information processing apparatuses illustrated in FIG. 2B.

FIG. 2C is a block diagram illustrating an example of a hardware configuration of the application management server 103. The application management server 103 includes a display unit 236, an operation unit 237, a storage unit 234, a control unit 231, and a network communication unit 235.

Descriptions of the display unit 236, the operation unit 237, the storage unit 234, the control unit 231, and the network communication unit 235 are the same as the description of the client terminal 101, and redundant descriptions thereof will be omitted.

The application management server 103 will be described below as an information processing apparatus having the hardware configuration illustrated in FIG. 2C. However, the application management server 103 may be configured as a plurality of information processing apparatuses.

FIG. 2D is a block diagram illustrating an example of a hardware configuration of the cloud printing support printer 104. The cloud printing support printer 104 includes a display unit 246, an operation unit 247, a storage unit 244, a control unit 241, a network communication unit 245, and a printing unit 248.

The display unit 246 is an apparatus for displaying information to the user in real time, such as a touch panel and a light emitting diode (LED) display on the cloud printing support printer 104.

The operation unit 247, an apparatus for receiving an input from the user, may include hardware keys such as a numeric keypad in addition to a touch panel. The descriptions of the storage unit 244 and the control unit 241 are the same as the description of the client terminal 101, and redundant descriptions thereof will be omitted.

The network communication unit 245, an apparatus for communicating with the external network 107, has a role of receiving mainly print data and transmitting the status of the cloud printing support printers 104, such as an error, to an external server.

The printing unit 248 is an apparatus for performing a series of sheet feed, printing, and discharging operations for a sheet prepared in a cassette or tray, thus achieving print processing. Applicable printing methods are not limited to a particular electrophotographic printing method or an inkjet printing method. The printing unit 248 includes a double-sided printing unit used at the time of sheet discharge and finishing apparatuses for stapling and punching.

Although the present exemplary embodiment has been described above centering on a single function printer having only a printing function as an example of a cloud printing support printer 104, a multi-function printer (multi-function peripheral) having a scanner function and a facsimile function is also applicable.

The hardware configuration of the printer 106 illustrated in FIG. 1 is also similar to the hardware configuration in FIG. 2D.

FIG. 2E is a hardware block diagram illustrating an example of the online support server 105. Although the present exemplary embodiment will be described below on the premise that the online support server 105 is configured as one information processing apparatus, the online support server 105 may be configured as a plurality of information processing apparatuses. The online support server 105 includes a display unit 256, an operation unit 257, a storage unit 254, a control unit 251, and a network communication unit 255. Descriptions of the display unit 256 and the operation unit 257 are the same as the descriptions of the display unit 216 and the operation unit 217 of the client terminal 101, respectively, and redundant descriptions thereof will be omitted. The storage unit 254 is a memory device such as an HDD and SSD. The storage unit 254 stores a file describing information for extending the function provided by the client terminal 101.

The control unit 251 includes a CPU 252 and a memory 253. The CPU 252 controls the entire online support server 105. The memory 253 is used for processing to be executed by the CPU 252. The network communication unit 255 is an interface used by the online support server 105 to communicate with the client terminal 101. The online support server 105 receives a request for acquiring files stored in the storage unit 254 and transmits the corresponding files to the client terminal 101 via the network communication unit 255.

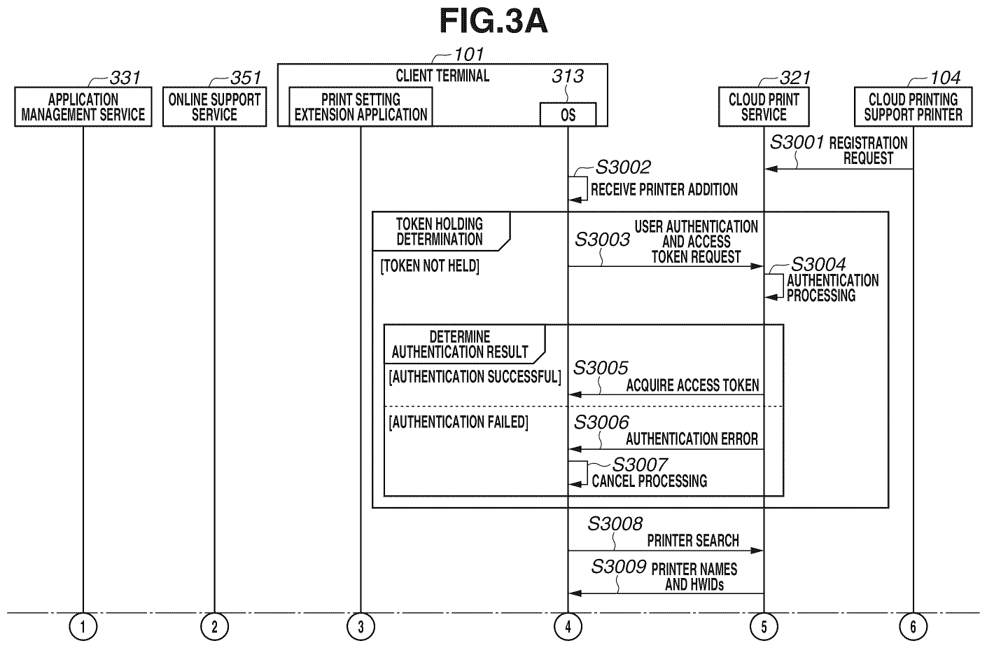

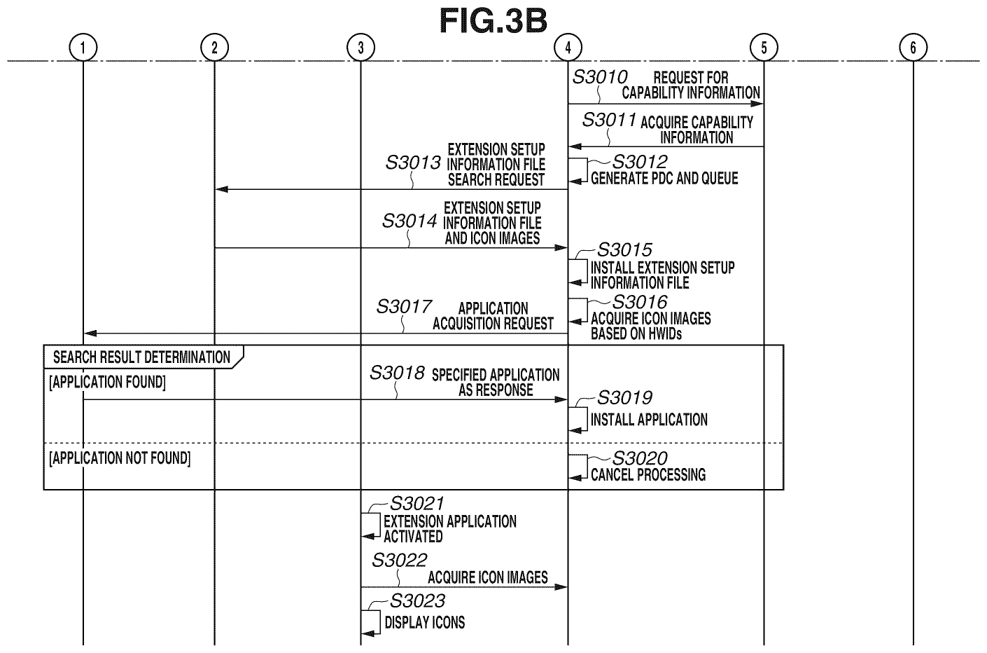

Examples of user operations and a sequence between each piece of software and a print service according to the present exemplary embodiment will be described below with reference to FIG. 3. In the examples to be described below, a cloud printing support printer 104 is registered in the cloud print service 321, and the icon is acquired based on the cloud print service 321.

The cloud printing support printer 104 receives from the user an operation for registering the cloud printing support printer 104 in the cloud print service 321. In step S3001, the cloud printing support printer 104 transmits printer device identification information and a printer registration request to the cloud print service 321 according to the printer registration operation. Examples of the device identification information transmitted to the cloud print service 321 include a hardware identifier (HWID) assigned for each printer model.

The device identification information can be any type of information as long as a printer model can be identified.

Upon reception of the registration request, the cloud print service 321 transmits the uniform resource locator (URL) of the cloud print service 321 for printer registration to the cloud printing support printer 104. The user accesses the URL from the cloud printing support printer 104 or the information processing apparatus, and inputs the user UD and password for using the cloud print service 321 to log into the cloud print service 321. When the user login is successful, the cloud print service 321 transmits a request for acquiring information necessary for printer registration to the cloud printing support printer 104. In response to the request, the cloud printing support printer 104 transmits printer information to the cloud print service 321.

Then, the cloud print service 321 registers the information for the cloud printing support printer 104 and generates a print queue for the cloud printing support printer 104. In this case, the cloud print service 321 acquires capability information of the cloud printing support printer 104 and associates the capability information with the generated print queue. The capability information represents the functions equipped on the printer and refers to two-sided printing capable information, color printing capable information, stapling capable information, and other information necessary for the user to make print setting at the time of printing. As a specific example, the use of IPP as a communication protocol is assumed. The cloud printing support printer 104 transmits the capability information to the cloud print service 321 by using attribute values defined in IPP. Attribute values not defined in IPP are notified to the cloud print service 321 as they are.

The installation of a print setting extension application 312 will be described below. This installation is performed when the user performs, on the client terminal 101, a setup operation for performing printing on the cloud printing support printer 104.

An OS 314 of the client terminal 101 receives an operation for setting up the cloud printing support printer 104 by the user. The following operation is an example of the operation for setting up the cloud printing support printer 104.

In step S3002, the OS 314 of the client terminal 101 receives a printer addition instruction from the user.

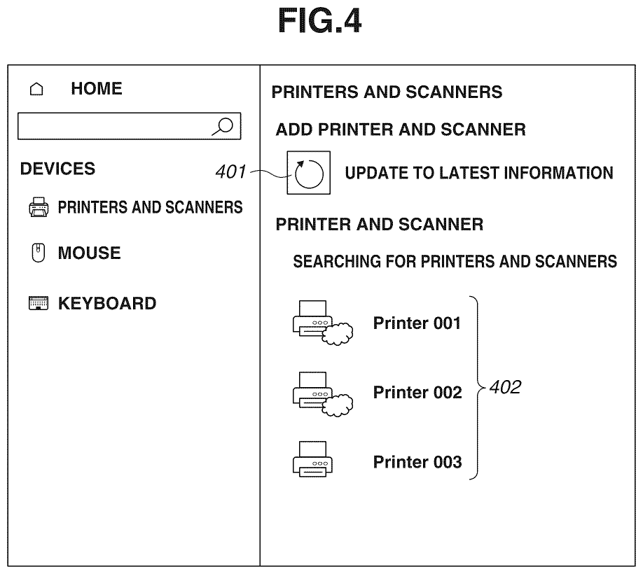

FIG. 4 illustrates a screen for managing information about the print queue registered in the OS 314 of the client terminal 101, displayed on the client terminal 101. When the user selects a button 401, a printer search instruction is input to the OS 314.

Upon reception of the printer search instruction, the OS 314 determines whether the client terminal 101 holds a token for acquiring information from the cloud print service 321.

In a case where the client terminal 101 does not hold a token, the OS 314 displays a screen for entering user information (login name and password). In step S3003, the OS 314 transmits the user information entered via the screen to the cloud print service 321 to issue a request for user authentication and an access token.

In step S3004, the cloud print service 321 performs authentication processing by using the user information received from client terminal 101. Upon completion of the authentication processing, the cloud print service 321 notifies the client terminal 101 of the result of the authentication processing.

In a case where the user authentication is successful, the processing proceeds to step S3005. In step S3005, the OS 314 acquires the access token from the cloud print service 321.

In a case where the user authentication fails in step S3004, the processing proceeds to step S3006. In step S3006, the cloud print service 321 notifies the OS 314 of the client terminal 101 of an authentication error.

In step S3007, the OS 314 of the client terminal 101 cancels processing based on the received authentication error information. The OS 314 completes the processing illustrated in FIG. 3.

In a case where the client terminal 101 already holds the access token, the processing proceeds to step S3008. In step S3008, the OS 314 of the client terminal 101 searches for printers registered in the cloud print service 321 and printers connected to the network 107.

In step S3008, after supplying the access token, the OS 314 of the client terminal 101 transmits a request for acquiring printer information registered in the cloud print service 321.

The cloud print service 321 identifies the tenant ID to which the user identified by the access token attached to the acquisition request belongs, and generates a list of printers associated with the tenant ID to which the user belongs.

In step S3009, the OS 314 of the client terminal 101 acquires the printer list generated by the cloud print service 321 and the device identification information for each printer.

The OS 314 displays the printer list on the client terminal 101 based on the printer information acquired from the cloud print service 321 and the printer information detected in the search in the network 107. Referring to FIG. 4, a list 402 displays the printer information received from the cloud print service 321 and printers searchable in a local network.

Then, the user selects the printer information for the printer to be registered in the client terminal 101, from among the displayed printers. In step S3010, the OS 314 transmits a request for the capability information for the selected cloud printing support printer 104 to the cloud print service 321. The OS 314 determines the attribute about which the inquiry (request) is to be made.

In step S3011, in response to the inquiry, the cloud print service 321 transmits the capability information for the cloud printing support printer 104 to the OS 314. The capability information for the cloud printing support printer 104 may be the capability information acquired at the time of printer registration. Alternatively, the cloud printer service 321 may acquire the latest capability information from the cloud printing support printer 104 upon reception of the inquiry from the OS 314.

If the cloud print service 321 does not store the capability information for the attribute inquired by the OS 314 of the client terminal 101, the cloud print service 321 does not respond to the OS 314.

Then, the OS 314 starts the installation of the cloud printer driver 311 for generating print data to be transmitted to the printer selected by the user.

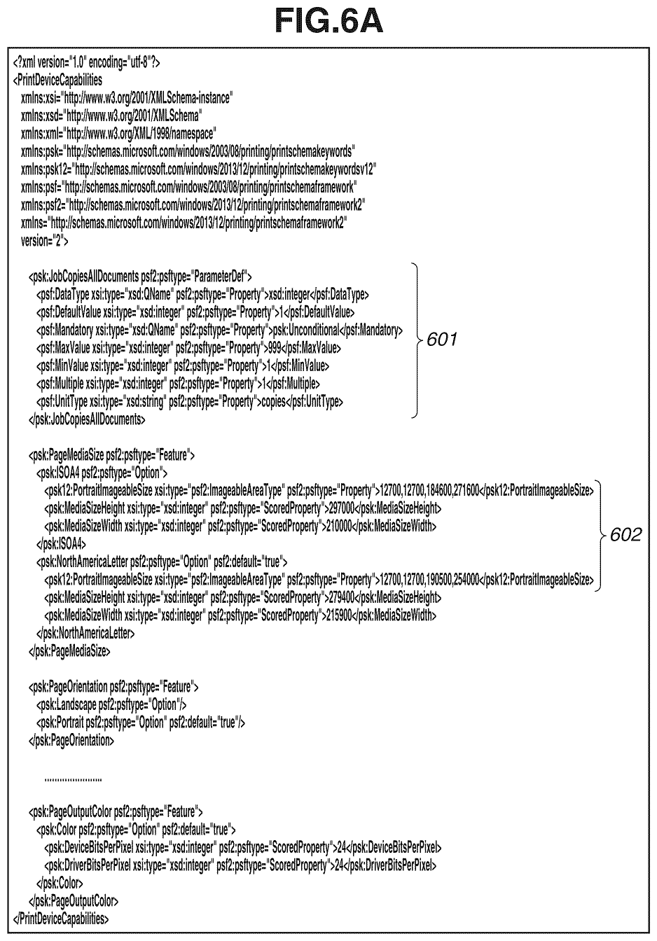

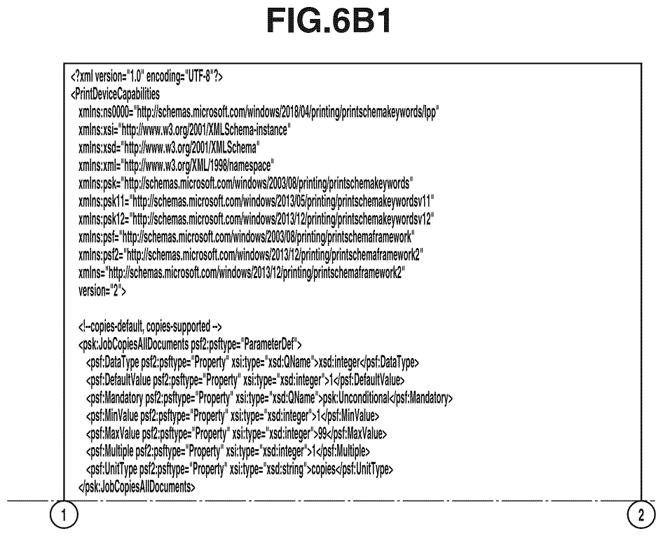

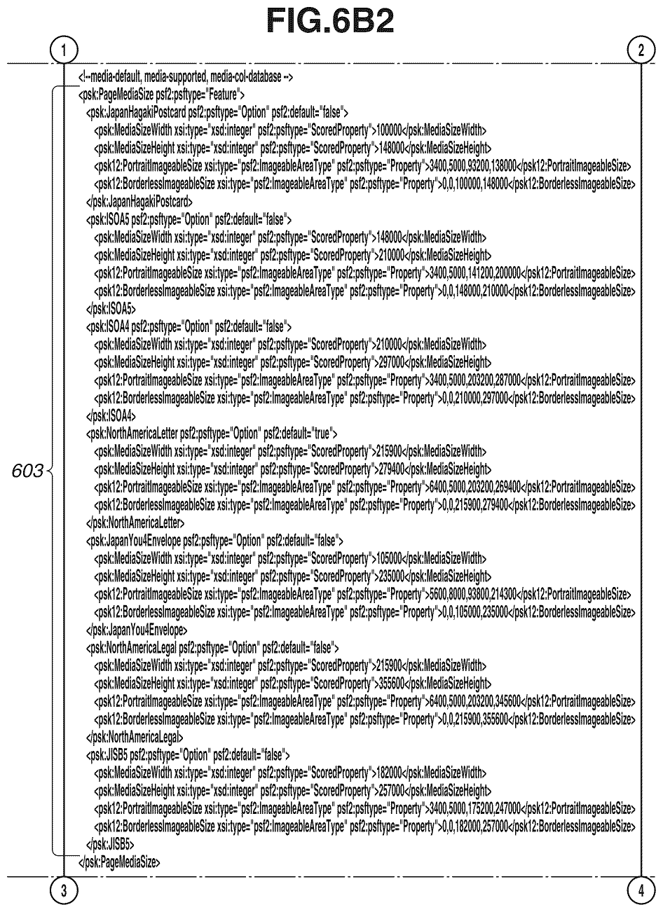

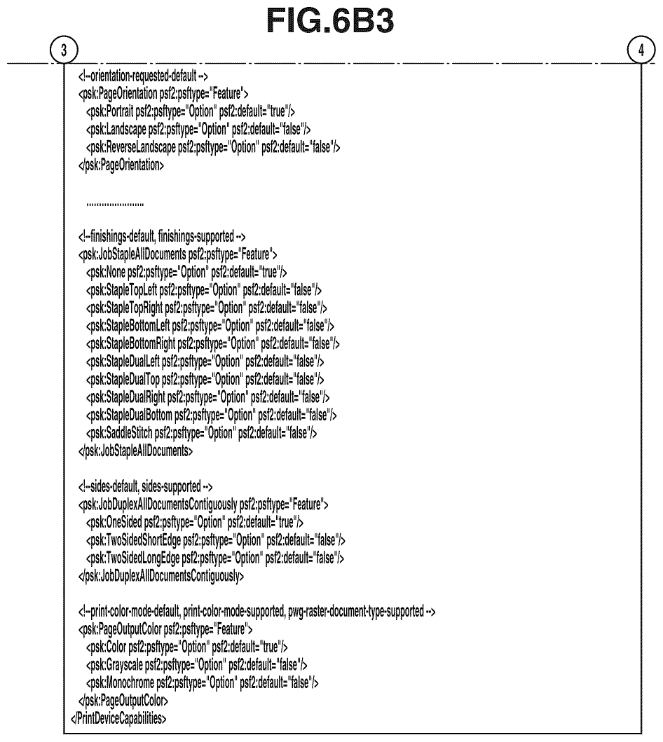

In step S3012, the OS 314 generates a print queue of the cloud printer driver 311 having basic device capability information bundled in the OS 314. The device capability information refers to definition information required to generate print setting capability information for the printer driver, for example, information described in eXtended Markup Language (XML) such as PrintDeviceCapabilites. FIG. 6A illustrates an example of device capability information bundled in the OS 314. A description 601 indicates capability information about the number of copies, i.e., the minimum number of copies is 1, and the maximum number of copies is 999. A description 602 indicates capability information about the sheet size. “Feature” indicates a function name. “Option” indicates information about options selectable for the function, i.e., two different selectable sheet sizes “A4” and “LETTER”. This information is associated with the print queue and managed by the OS 314.

Then, the OS 314 updates the device capability information configuring the cloud printer driver 311 by using the capability information acquired from the cloud print service 321. FIGS. 6B1, 6B2 and 6B3 illustrate an example of the device capability information updated by using the capability information acquired from the cloud print service 321. A description 603 indicates the sheet size after the update. “Option” other than “A4” and “LETTER” is added to “PageMediaSize” as sheet sizes printable by the cloud printing support printer 104. The OS 314 registers the printer HWID and the device capability information for the printer, and the identification information for the printer driver to be used, in association with the print queue.

This completes the installation of the cloud printer driver 311.

Then, in association with the printer, the OS 314 starts processing for installing an application for extending the cloud printer driver.

The OS 314 performs processing for supplying identification addition information to the device identification information. This processing is used for the online support server 105 when acquiring the extension setup information file 700. The identification addition information is to be a character string different from normal device identification information.

According to the present exemplary embodiment, to distinguish from applications of other devices, the OS 314 supplies the identification addition information (“PrinterApp_”) indicating that the application supports the printer, to the device identification information.

“PrinterApp_” is to be considered as illustrative, and other character strings, numbers, and symbols are also applicable.

If the device identification information for the cloud printing support printer 104 is device001, for example, the device identification information after the identification addition information supply processing becomes PrinterApp_device001.

In step S3013, the OS 314 transmits a request for search in the extension setup information file 700 to the online support service 351. The OS 314 transmits the device identification information with the supplied identification addition information to the online support service 351.

In step S3014, if the online support service 351 holds the extension setup information file 700 including the target device identification information, the online support service 351 transmits the extension setup information file 700 to the OS 314. In step S3014, the online support service 351 further transmits the icon images corresponding to the extension setup information file to the client terminal 101.

FIGS. 7A and 7B illustrate an example of the extension setup information file 700 describing the device identification information including processing for “Supplying the identification addition information to the device identification information for the cloud printing support printer” in the identification addition information supply processing.

A description 701 indicates the application identification information for the print setting extension application 312 corresponding to the extension setup information file 700.

A description 702 indicates the device identification information for the device corresponding to the extension setup information file 700. The description 702 describes the device identification information supplied with identification addition information “PrinterApp_”. The online support service 351 identifies the extension setup information file 700 describing PrinterHardwareId 702 which is the same as the device identification information received from the client terminal 101.

DDInstall 703 indicates that addition information is present for the printer identified by PrinterHardwareId 702. DDInstall 703 describes that DeviceIconProperty is addition information. DeviceIconProperty indicates that the printer icon image is registered in the online support service 351.

DeviceIconProperty 704 indicates the location in the client terminal 101 where the acquired icon image file name and the icon image data are to be stored. DIRID 13 is identification information for the directory specified when the client terminal 101 stores the icon image.

FIG. 7A illustrates an example where one icon image is associated with one HWID device. A plurality of icon images may be associated with one HWID device.

For example, one printer may support both the cloud printer driver 311 and the local printer driver 313. In this case, if the same icon image is displayed in a case of using the cloud printer driver 311 and a case of using the local printer driver 313, the user will find it difficult to distinguish between printer drivers to be used. According to the present exemplary embodiment, therefore, different icon images are displayed between a case of using the cloud printer driver 311 and a case of using local printer driver 313.

To display different icon images between the cloud printer driver 311 and the local printer driver 313, DDInstall 703 and DeviceIconProperty 704 in the extension setup information file 700 are changed as illustrated in FIG. 7B.

DDInstall 705 is described in the extension setup information file 700 instead of DDInstall 703 in FIG. 7A. DeviceIconProperty 706 is described in the extension setup information file 700 instead of DeviceIconProperty 704 in FIG. 7A.

“AddProperty=CloudDeviceIconProperty” indicates that there is an icon image to be used when generating a print queue for using the cloud printer driver 311. The icon image file has a name “vendor1.icon”. The client terminal 101 stores the icon image in the directory identified by DIRID 13.

“AddProperty=LocalDeviceIconProperty” indicates that there is an icon image to be used when generating a print queue using the local printer driver 313. The icon image file has a name “vendor2.icon”. The client terminal 101 also stores the icon image in the directory DIRID 13.

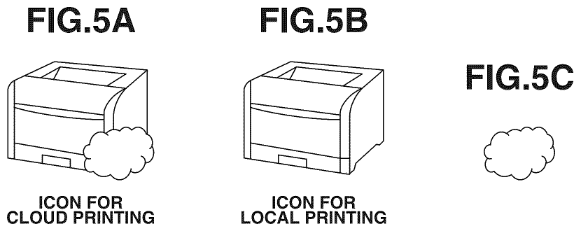

FIGS. 5A to 5C illustrate examples of icon images acquired by using extension setup information file 700.

FIG. 5A illustrates an icon image associated with a print queue using the cloud printer driver 311. FIG. 5A illustrates the image corresponding to “vendor1.ico” in FIG. 7B. A cloud image is drawn on the printer image to allow the user to recognize the use of the cloud print service 321.

FIG. 5B illustrates an icon image associated with a print queue using the local printer driver 313. FIG. 5B illustrates the image corresponding to “vendor2.ico” in FIG. 7B. Since the local printer driver 313 directly communicates with a printer without interposing the cloud print service 321, no cloud image is drawn on the printer image.

The above-described icon specification method is to be considered as illustrative. Any other methods are also applicable as long as an icon image is acquired based on the extension setup information file 700.

As described above, the online support service 351 provides the client terminal 101 with icon images together with the extension setup information file 700. This enables the client terminal 101 to display the icon images corresponding to the printers to be used for printing.

The sequence diagram in FIG. 3 will be described again below. In step S3015, the OS 314 installs the extension setup information. In step S3015, the OS 314 reads the contents of the extension setup information file 700 and at the same time writes the contents in the registry.

Then, the OS 314 stores the icon image acquired from the online support service 351 in the directory specified by the extension setup information file 700. If a plurality of icon images is specified by the extension setup information file 700, the OS 314 stores the plurality of icon images in the directory specified in extension setup information file 700.

The icon images are downloaded and then stored in the directory specified by the extension setup information file 700. However, the directory specified by the extension setup information file 700 is assumed to be not a region accessible by the print setting extension application 312.

According to the present exemplary embodiment, therefore, the OS 314 further stores the stored icon images in a predetermined directory. The predetermined directory is, for example, QueuePropertyBag (not illustrated). QueuePropertyBag, an architecture mounted on Windows®, is a data store for defining properties or data Binary Large OBject (BLOB) to be used by drivers and applications on a read only basis.

In this case, however, icon images are stored in any desired form. For example, icon images are stored for each piece of the extension setup information without being distinguished for each queue, and no storage region is distinguished if a plurality of icon images is acquired, in the first place. Storing icon images in this way enables the print setting extension application 312 to use the acquired icon images when installing the extension setup information file 700.

In step S3017, the OS 314 transmits a request for acquiring the application having the same application ID identified from the extension setup information file 700, to the application management service 331.

In step S3018, if the application management service 331 stores the print setting extension application 312 corresponding to the requested application ID, the application management service 331 transmits the print setting extension application 312 to the client terminal 101 as a response. The print setting extension application 312 transmitted in step S3018 is the application identified by the application ID.

In step S3019, the OS 314 installs the acquired print setting extension application 312 in association with the print queue on the side of the client terminal 101. More specifically, the application ID is prestored as information for the print queue in the registry of the OS 314. When calling a generated print queue, the OS 314 activates the installed print setting extension application 312 by using the information.

In step S3020, if the application management service 331 does not hold the print setting extension application 312 corresponding to the requested application ID, the OS 314 completes the installation of the cloud printer driver 311 and cancels the application installation processing.

Up to step S3020 is processing related to the installation of the print setting extension application 312.

In step S3021, after the print setting extension application 312 is installed in the OS 314, the user activates the print setting extension application 312. The print setting extension application 312 is activated when selected by the user in the application list screen or the menu screen provided by the OS 314. The print setting extension application 312 may be activated at a timing other than the above-described timing.

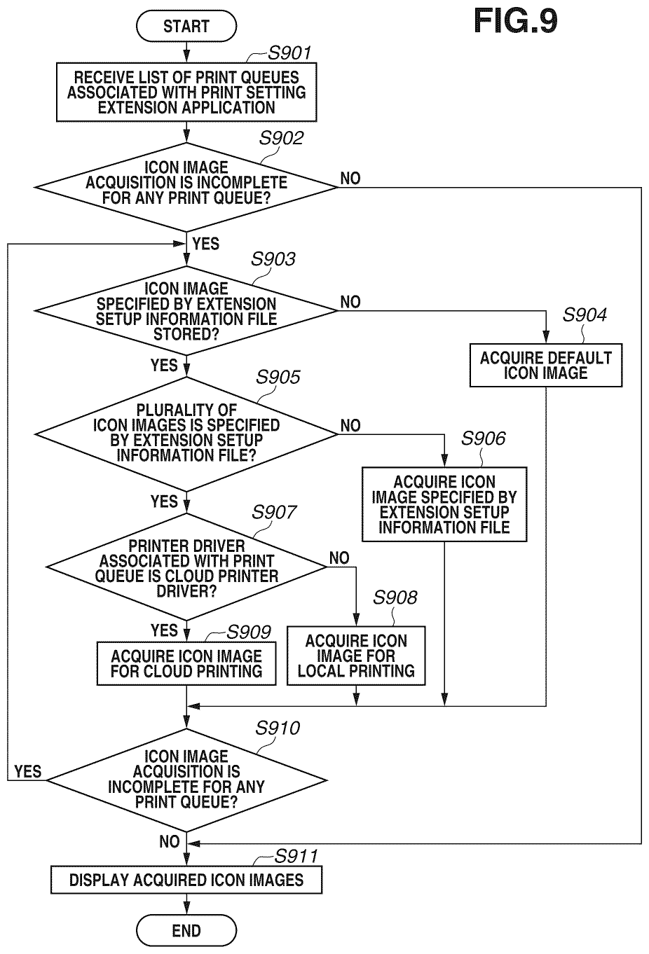

In step S3022, when the print setting extension application 312 is activated, the application 312 acquires the icon images stored in step S3016. The processing to be performed by the print setting extension application 312 in step S3022 will be described below with reference to FIG. 9.

In step S3023, the print setting extension application 312 displays the acquired icon images on the application 312.

The above-described series of processing registers the cloud printing support printer 104 in the cloud print service 321, generates a print queue using the cloud print service 321 in the client terminal 101, and installs the print setting extension application 312.

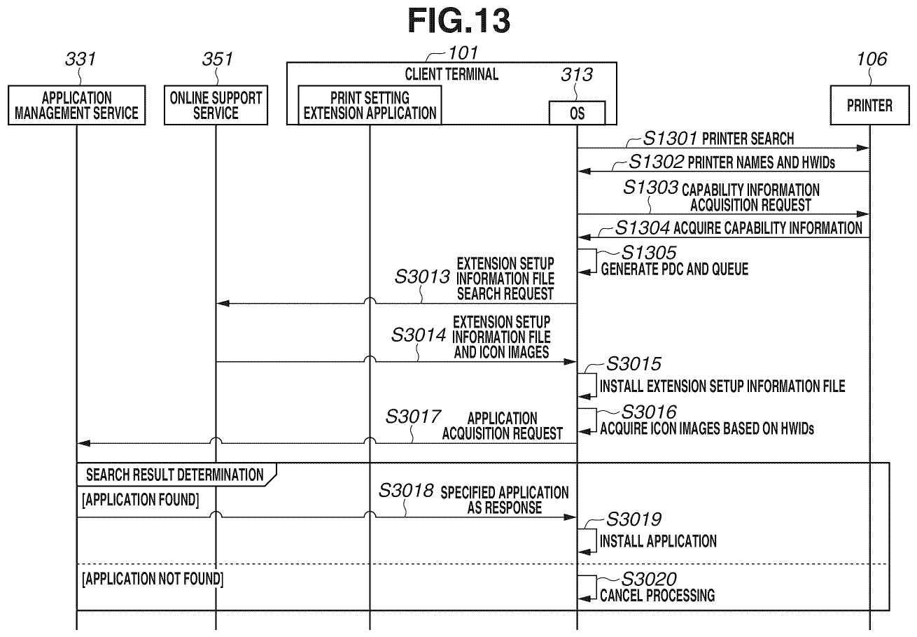

Processing for installing the local printer driver 313 and then installing the print setting extension application 312 will be described below with reference to FIG. 13. Steps for performing similar processing to the processing in FIG. 3 are assigned the same reference numerals (step numbers) as those in FIG. 3.

In step S1301, the OS 314 searches for printers connected to the network 107. In step S1302, the printer 106 responds to the printer search request transmitted by the OS 314.

The OS 314 displays a list of printers having responded and receives a selection of a printer from the user. In step S1303, the OS 314 transmits a capability information acquisition request to the printer selected by the user. In step S1303, the OS 314 makes an inquiry about the capability information for the printer 106 by using a Get-Printer-Attributes operation defined in IPP. In step S1304, the printer 106 transmits the capability information to the OS 314 as a response. In step S1305, the OS 314 installs the local printer driver 313 and generates a print queue for associating the local printer driver 313 with the device identification information and the capability information for the printer 106.

The subsequent processing is similar to the processing in FIG. 3. The icon image acquisition is also similar to that in a case where the cloud printer driver 311 is used.

According to the present exemplary embodiment (FIG. 1), the cloud printing support printer 104 and the printer 106 are illustrated as different printers. The cloud printing support printer 104 may be able to print the print data generated by the local printer driver 313. For example, assume a case where the client terminal 101 and the cloud printing support printer 104 are connected to the same network. When the client terminal 101 performs printer search by using the search function of the OS 314, the client terminal 101 detects the cloud printing support printer 104. When the user selects the cloud printing support printer 104 from the search result, the OS 314 generates a print queue for transmitting the print data generated by the local printer driver 313 to the cloud printing support printer 104 without interposing the cloud print service 321. The print queue generation processing and the installation processing for the print setting extension application 312 are similar to the processing in FIG. 13.

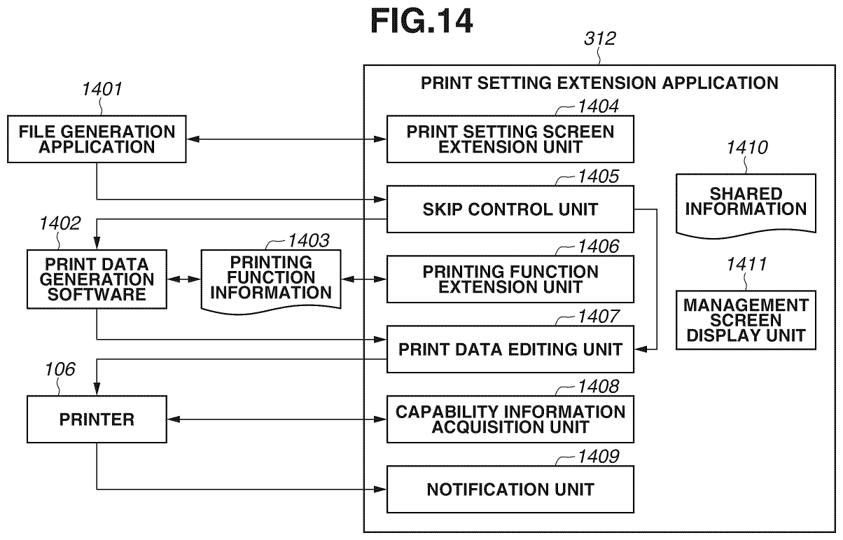

FIG. 14 is a schematic view illustrating print processing using the print setting extension application 312 installed in the client terminal 101 in the sequence in FIG. 3 or 13.

The print setting extension application 312 stores software modules 1404 to 1409 and shared information 1410. Each module will be described below.

A file generation application 1401 generates document data and presentation data and serves as a spreadsheet. This application is installed in the client terminal 101 to output printing target image data.

Print data generation software 1402 is provided by the OS 314 of the client terminal 101. The print data generation software 1402 performs processing for converting print setting values into attribute values defined based on a predetermined protocol, and processing for converting the image data output by the file generation application 1401 into data with a predetermined format. The predetermined protocol is, for example, InternetPrintingProtocol. Examples of the predetermined format include page description format (PDF) and Printer Working Group (PWG) Raster. The printing function information 1403 is the device capability information for the cloud printing support printer 104 and the printer 106. The printing function information 1403 is also referred to as a page description code (PDC). The OS 314 executes a Get-Printer-Attributes operation in IPP to acquire functions (attribute information) and setting values (attribute values) usable by the printer 106. The OS 314 writes the acquired attribute information and attribute values interpretable by the OS 314, to the printing function information 1403. The print settings and capability information based on the printing function information 1403 are provided to the file generation application 1401 and the print setting extension application 312.

Although a printing apparatus connected to the client terminal 101 will be described as the printer 106, the cloud print server 102 may be connected instead of the printer 106.

The print setting extension application 312 provides four different major functions. The four functions include extending the printing function information 1403, displaying a print setting screen, editing the print data, and displaying a print apparatus management screen.

Firstly, the function of extending the printing function information 1403 will be described below. A capability information acquisition unit 1408 communicates with the printer 106 to acquire the capability information for the printer 106. The capability information acquisition unit 1408 acquires the capability information from the printer 106 by using the Get-Printer-Attributes operation. The OS 314 also has a function of acquiring the capability information from the printer 106. However, the capability information acquisition unit 1408 can also acquire the capability information for setting items and setting values not acquired by the OS 314. For example, the capability information acquisition unit 1408 acquires a user-defined sheet size registered in the printer 106 by the user, and capability information related to needleless binding for binding sheets without using needles. The capability information acquired by the capability information acquisition unit 1408 is written to the printing function information 1403 by the printing function extension unit 1406.

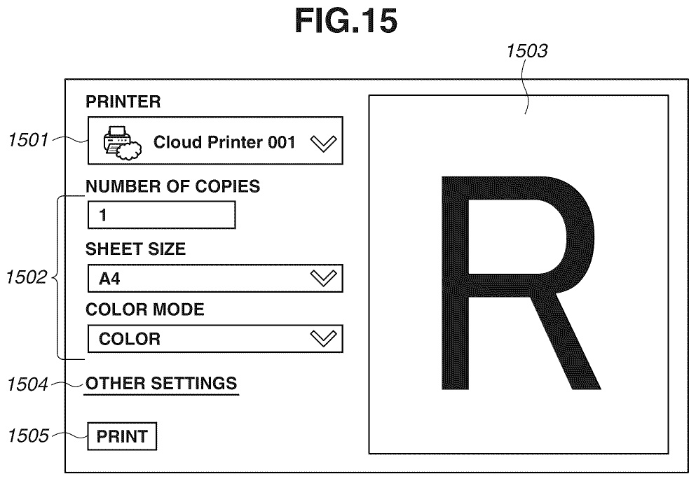

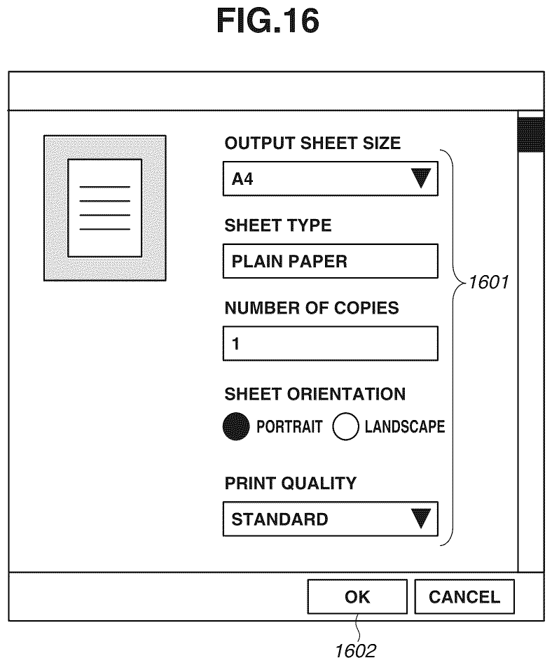

The display of the print setting screen by the print setting extension application 312 will be described below. For example, the file generation application 1401 displays the print setting screen in FIG. 15. A region 1501 is used to select a print queue used for printing. A region 1502 is displayed by the file generation application 1401 based on the capability information provided by the OS 314 and receives the settings of the number of copies, the sheet size, and the color mode. The region 1502 is displayed by using PrintCapabilities generated based on the printing function information 1403. A file preview image 1503 is output by the file generation application 1401. An object 1504 is used to activate the print setting extension application 312 corresponding to the print queue selected in the region 1501. When the user selects the object 1504, an activation instruction is input to the print setting extension application 312. A print setting screen extension unit 1404 displays the print setting screen in FIG. 16.

The print setting screen extension unit 1404 acquires PrintCapabilities and PrintTicket based on the printing function information 1403 from the OS 314 and displays the print setting screen in FIG. 16. PrintCapabilities includes settable functions and setting values. Setting values set for each function are described in PrintTicket. A region 1601 is displayed based on PrintCapabilities and PrintTicket acquired from the OS 314. The print setting screen in FIG. 16 is a scrollable screen. When the user scrolls the screen, an object for setting undisplayed setting items appears. The print setting screen in FIG. 16 allows the user to set the setting values of setting items that cannot be set in the print setting screens provided by the file generation application 1401 and the OS 314. Examples of the setting items that cannot be set in the print setting screens provided by the file generation application 1401 and the OS 314 include setting items for bookbinding printing and setting items for needleless binding.

An object 1602 is used to apply the print settings set via the print setting screen provided by the print setting screen extension unit 1404 and issue an instruction for completing the display of the screen. When the user selects the object 1602, the print setting screen extension unit 1404 writes the setting values set via the screen in FIG. 16 to PrintTicket. This completes the description of the display processing for the print setting screen.

Editing of print data will now be described. When the user selects an object 1505 in FIG. 15, the file generation application 1401 outputs printing target image data. The file generation application 1401 outputs graphics device interface (GDI) format data or XML paper specification (XPS) format data.

If the file generation application 1401 outputs GDI format data, the OS 314 converts the data output by the file generation application 1401 into XPS format intermediate data. The OS 314 activates a skip control unit 1405 that notifies the print data generation software 1402 of a flag indicating whether to perform the Page Description Language (PDL) data generation by the print data generation software 1402.

If the omission of the PDL data generation processing is specified, the print data generation software 1402 converts the setting values described in PrintTicket into attribute values defined in IPP, and transmits the attribute values after the conversion and the intermediate data to the print data editing unit 1407. If the omission of the PDL data generation processing is not specified, the print data generation software 1402 performs processing for converting the intermediate data into PDL data. Then, the print data generation software 1402 transmits the PDL data after the conversion and information obtained by converting the setting values in PrintTicket into attribute values defined in IPP, to the print data editing unit 1407.

The print data editing unit 1407 edits the PDL data received from the print data generation software 1402. Editing of the PDL data includes layout processing for gathering image data of a plurality of pages to one page and processing for adding user-specified images and character strings to image data. The print data editing unit 1407 further converts the setting values in PrintTicket acquired from the OS 314, not converted into attribute values defined in IPP by the print data generation software 1402, into attribute values defined in IPP.

If the skip control unit 1405 instructs the print data generation software 1402 to skip the PDL data generation processing, the print data editing unit 1407 converts the intermediate data into PDL data. The PDL data after the conversion is transmitted to the printer 106 together with the attribute values converted by the print data generation software 1402 and the print data editing unit 1407. This completes the descriptions of processing for editing and transmitting print data.

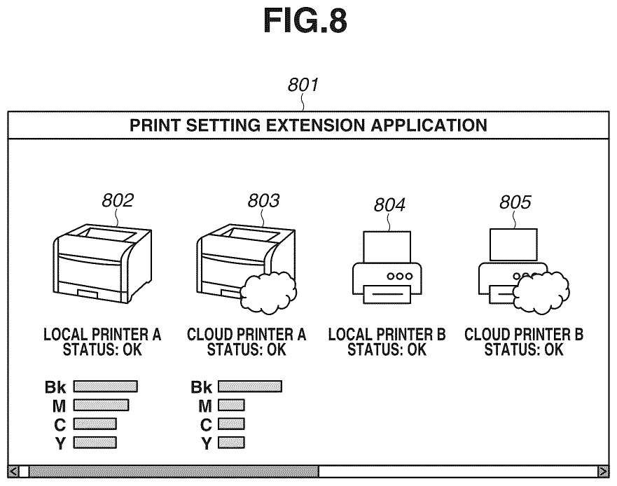

The display of the print apparatus management screen will be described below. The printing apparatus management screen appears in the following two different situations. One situation is a case where the OS 314 receives a notification from the printer 106, the user selects a pop-up displayed by the OS 314, and the OS 314 transmits a notification to a notification unit 1409 according to the selection. The other situation is a case where an instruction for activating the print setting extension application 312 is issued from the home screen provided by the OS 314. In this case, a management screen display unit 1411 operates to display the management screen in FIG. 8. FIG. 8 illustrates a print queue stored in association with the print setting extension application 312. The screen in FIG. 8 allows the user to confirm status information indicating the consumable statuses and the printing feasibility for each printing apparatus. When the print queue is selected, a device setting screen of the corresponding printing apparatus may be displayed. According to the present exemplary embodiment, the management screen display unit 1411 displays the images corresponding to the printing apparatuses associated with the print queue, by using the icon images acquired from the online support service 351.

FIG. 9 is a flowchart illustrating processing performed by the print setting extension application 312 to display the icon images acquired from the online support service 351. The processing of the flowchart illustrated in FIG. 9 is implemented when the CPU 212 executes a program provided by the print setting extension application 312.

The processing illustrated in FIG. 9 starts when the print setting extension application 312 is activated by a user operation and then the management screen display unit 1411 is executed. The user selects the print setting extension application 312 from the menu screen provided by the OS 314 to activate the print setting extension application 312.

In step S901, the CPU 212 receives a list of print queues stored in association with the print setting extension application 312 from the OS 314. The print queue list includes the names of the print queues.

In step S902, the CPU 212 determines whether the icon image acquisition is incomplete for any print queue included in the print queue list received from the OS 314. If the icon image acquisition is completed for all of the print queues acquired from the OS 314 (NO in step S902), the processing proceeds to step S911. If the icon image acquisition is incomplete for any print queue (YES in step S902), the processing proceeds to step to S903.

In step S903, the CPU 212 selects one print queue that has not acquired an icon image and refers to the extension setup information file 700 of the selected print queue to determine whether an icon image is stored. The CPU 212 determines whether the icon image specified by the extension setup information file 700 is stored in QueuePropertyBag.

If DeviceIconProperty is stored in the extension setup information file 700, the CPU 212 determines that the icon image is stored. If DeviceIconProperty is not included in the extension setup information file 700, the CPU 212 determines that no icon image is stored. If the CPU 212 determines that no icon image is stored (NO in step S903), the processing proceeds to step S904.

In step S904, the CPU 212 acquires the default icon image provided by the OS 314. The CPU 212 acquires the default icon image prepared by the OS 314, by using Application Programming Interface (API) provided by the OS 314, and stores the icon image in a region that can be referenced by the print setting extension application 312, in association with the print queue. The present exemplary embodiment has been described above on the premise that, if no printer-specific icon image is found, the icon image provided by the OS 314 is used. If no printer-specific icon image is found, the CPU 212 may acquire the default image prestored by the print setting extension application 312 as an icon image, and store the image, in association with the print queue.

In step S905, the CPU 212 determines whether a plurality of icon images is specified by the extension setup information file 700. The CPU 212 refers to AddProperty of DDInstall in the extension setup information file 700. If a plurality of DeviceIconProperty is described as AddProperty, the CPU 212 determines that there is a plurality of icon images. If one DeviceIconProperty is described (NO in step S905), the processing proceeds to step S906.

In step S906, the CPU 212 acquires the icon image acquired from the online support service 351 and stores the icon image in a region accessible by the print setting extension application 312, in association with the print queue. The CPU 212 acquires the icon image specified by the file name of the icon image described in the extension setup information file 700, from QueuePropertyBag. Although, in the present exemplary embodiment, the CPU 212 acquires the icon image from QueuePropertyBag, the icon image may be acquired from the directory where the icon image is stored by the CPU 212.

In step S907, in a case where the extension setup information file 700 includes information for a plurality of icon images, the CPU 212 determines whether the printer driver associated with the print queue is the cloud printer driver 311.

If the printer driver associated with the print queue is not the cloud printer driver 311 (NO in step S907), the processing proceeds to step S908. In step S908, the CPU 212 acquires the icon image for local printing and stores the icon image in a region accessible by the print setting extension application 312, in association with the print queue. The CPU 212 acquires from QueuePropertyBag the icon image having the file name specified by LocalDeviceIconProperty in the extension setup information file 700. The CPU 212 stores the acquired icon image in a region accessible by the print setting extension application 312, in association with the print queue. Although, in the present exemplary embodiment, the icon image is read from QueuePropertyBag, the icon image may be acquired from the directory where the icon image is stored by the CPU 212. If the printer driver associated with the print queue is the local printer driver 313 (NO in step S907), the acquired icon image includes only the printer image as illustrated in FIG. 5B.

If the printer driver associated with the print queue is the cloud printer driver 311 (YES in step S907), the processing proceeds to step S909. The CPU 212 acquires from QueuePropertyBag the icon image having the file name specified by CloudDeviceIconProperty in the extension setup information file 700. In step S909, the CPU 212 stores the acquired icon image in a region that can be referenced by the print setting extension application 312, in association with the print queue. Although, in the present exemplary embodiment, the icon image is read from QueuePropertyBag, the icon image may be acquired from the directory where the icon image is stored by the CPU 212. If the printer driver associated with the print queue is the cloud printer driver 311, the icon image in FIG. 5A is acquired.

In step S910, the CPU 212 determines whether the icon image acquisition is incomplete for any print queue in the print queue list. If the icon image acquisition is incomplete for any print queue (YES in step S910), the CPU 212 selects one print queue that has not acquired an icon image. Then, the processing returns to step S903. The CPU 212 can acquire the icon images for the print queue to be associated with the print setting extension application 312, by repetitively performing the processing in steps S903 to S910.

If the icon image acquisition is incomplete for none of the print queues (NO in step S910), the processing proceeds to step S911.

In step S911, the CPU 212 displays the print queues and icon images on the display unit 216. FIG. 8 illustrates an example of an icon image list 801 displayed by the print setting extension application 312. FIG. 8 illustrates a state where the print setting extension application 312 is associated with four different print queues.

The print queue 802 is associated with the local printer driver 313, and therefore the icon image illustrated in FIG. 5B appears. The print queue 803 is associated with the cloud printer driver 311, and therefore the icon image illustrated in FIG. 5A appears. The icon image is changed according to the associated printer driver in this way. The screen displayed by the print setting extension application 312 makes it easier for the user to identify which print queue is associated with which printer driver.

Print queues 804 and 805 are supplied with icon images to be supplied if the icon image acquisition from the online support service 351 fails. The icon images to be associated with the print queues 804 and 805 are the icon images supplied in step S904 in FIG. 9. When supplying the default icon image, the CPU 212 changes the icon image according to whether the printer driver associated with the print queue is the cloud printer driver 311 or the local printer driver 313. This processing enables distinguishably displaying which print queue is connected with the cloud print service 321.

The CPU 212 may prestore the icon images acquired in steps S904, S906, S908, and S909. When the print setting extension application 312 is activated next time, the processing may proceed to step S911 (NO in step S902), and the CPU 212 may display the screen without acquiring the icon images.

Processing performed when the print setting extension application 312 is activated from the home screen provided by the OS 314 has been described above with reference to FIG. 9. When the print setting extension application 312 is activated from the screen provided by the file generation application 1401 for generating document data and presentation data, the print setting extension application 312 may acquire the icon images. When a predetermined user operation is received in the screen displayed by the file generation application 1401, the processing illustrated in FIG. 9 is performed. In this case, in step S901, the print setting extension application 312 is notified of one print queue selected by the file generation application 1401, not all of the print queues associated with the print setting extension application 312. The print setting extension application 312 performs processing in step S902 and subsequent steps for one print queue notified.

The CPU 212 may perform the processing illustrated in FIG. 9 when the print setting extension application 312 is activated from the print setting screen provided by the OS 314, not from the print setting screen provided by the file generation application 1401. Also in this case, like the case of activating the print setting extension application 312 from the file generation application, one print queue selected by the OS 314 is notified to the print setting extension application 312 in step S901. The print setting extension application 312 performs the processing in step S902 and subsequent steps for the one print queue notified.

A method for changing the icon image to be acquired depending on the extension setup information and the diver type has been presented as above as a method for acquiring one icon image.

The exemplary embodiment has been described above centering on a case where the icon images are stored in a region named QueuePropertyBag, and the print setting extension application 312 reads and uses the icon images.

The storage location of the icon images is not limited thereto. For example, a storage area for each print queue may be prepared in the storage unit 214. In this case, the CPU 212 stores the icon images acquired in step S3014 in FIG. 3 in a storage area provided for each print queue. The print setting extension application 312 acquires the icon image from the storage area of the print queue associated with the application 312.

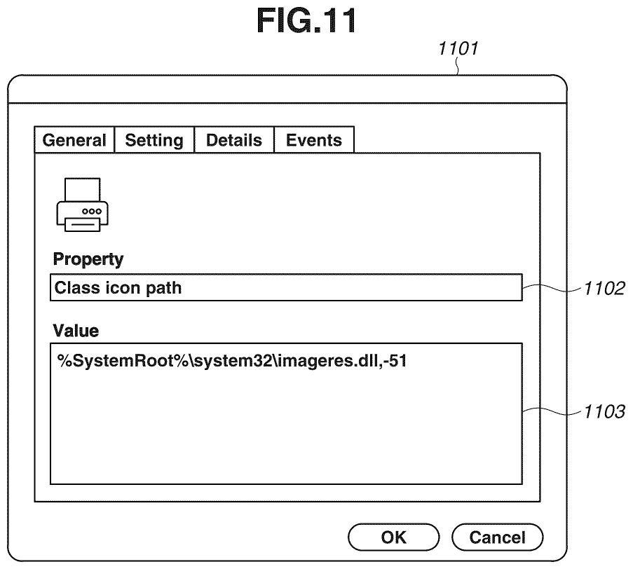

The acquired icon images may be stored in a dynamic link library (DLL) file. In this case, an API for acquiring an icon image by using a print queue as an argument is prepared. The print setting extension application 312 may acquire the icon image by using the API. In addition to the above-described API-based method, an icon image may be acquired by using an API using the file path storing the icon image as an argument. For example, information about the print queue is managed as illustrated in FIG. 11. A screen 1101 in FIG. 11 displays information about a print queue provided by the OS 314 of the client terminal 101. Property 1102 indicates which piece of information about the print queue is to be displayed in Value 1103. “Class icon path” indicates that the file path storing the icon image is displayed in Value 1103. The print setting extension application 312 may acquire the icon image from the location indicated by Value 1103 of “Class icon path”.

The present exemplary embodiment has been described above centering on a method in which the print setting extension application 312 acquires the icon images acquired at the time of installation of general-purpose printer drivers different from printer drivers from printer vendors. The present exemplary embodiment changes the icon image according to the printer driver to be used to allow the user to visually recognize that the print queue uses a different function.

The first exemplary embodiment has been described above centering on a case where two different icon images (the icon image for local printing and the icon image for cloud printing) are associated with the extension setup information file 700. A second exemplary embodiment will be described below centering on a method for distinguishably displaying the icon image for local printing and the icon image for cloud printing even if only the icon image for local printing is associated with the extension setup information file 700.

This method assumes an example case of a printer that originally did not support cloud printing and thus no icon image with a cloud as illustrated in FIG. 5A was provided, however, the firmware of the printer was updated afterward so that the printer has come to support cloud printing.

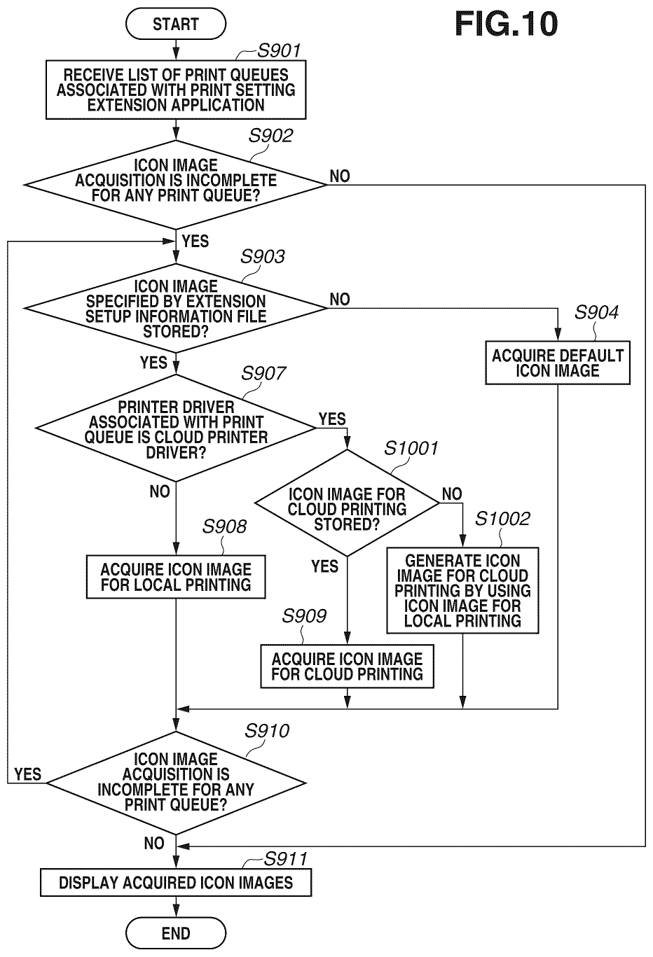

FIG. 10 is a flowchart illustrating processing according to the second exemplary embodiment. This processing is implemented when the CPU 212 executes a program provided by the print setting extension application 312. The hardware configuration of each apparatus is similar to that according to the first exemplary embodiment. Steps for performing similar processing to the processing according to the first exemplary embodiment are assigned the same reference numerals (step numbers) as those according to the first exemplary embodiment.

In step S907, the CPU 212 determines whether the printer driver associated with the print queue is the cloud printer driver 311. If the printer driver associated with the print queue is the cloud printer driver 311 (YES in step S907), the processing proceeds to step S1001. In step S1001, the CPU 212 determines whether the icon image for cloud printing is stored. For example, the CPU 212 references the extension setup information file 700 and, if there is “CloudDevicelconProperty” in “AddProperty”, determines that the icon image for cloud printing is stored.

If the CPU 212 determines that the icon image for cloud printing is not stored (NO in step S1001), the processing proceeds step S1002. In step S1002, the CPU 212 generates an icon image for cloud printing by using the icon image for local printing. The CPU 212 references the extension setup information file 700 and acquires the icon image for local printing from the registry or QuepropertyBag. The icon image for local printing is, for example, the image illustrated in FIG. 5B. Further, the CPU 212 acquires the image illustrated in FIG. 5C from the storage area that can be referenced by the print setting extension application 312. Although, in this case, a cloud image is drawn as an example of an image indicating the use of the cloud print service 321, other images are also applicable. For example, an image indicating the logo of the cloud print service 321 is also applicable. The CPU 212 supplies the image illustrated in FIG. 5C stored by the print setting extension application 312 to the acquired image for local printing, and stores the resultant image in a storage area that can be referenced by the print setting extension application 312. This processing enables distinguishably displaying the icon image for local printing and the icon image for cloud printing even if the image illustrated in FIG. 5A is not included in the extension setup information file 700.

This enables the print setting extension application 312 to display the icon images corresponding to the print queues for different models. Even with the print queue for the same model, the displayed icon image can be differentiated according to whether the driver associated with the print queue is the local printer driver 313 or the cloud printer driver 311. The print setting extension application 312 acquires the icon images by using the structure of the extension setup information file 700 for associating the print setting extension application 312 with the standard driver. This processing enables providing the user with the latest icon images even without updating the print setting extension application 312. In addition, the print setting extension application 312 does not need to store a large number of icon images, preventing the application 312 from getting heavy and possibly resulting in an effect of improving user convenience.

### Other Exemplary Embodiments

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-081355, filed May 17, 2023, which is hereby incorporated by reference herein in its entirety.

What is claimed is:

1. A computer readable storage medium storing a computer-executable program of instructions for causing a computer to perform a method comprising:
acquiring an icon image of a first printer based on identification information acquired from the first printer;
acquiring an icon image of a second printer based on identification information for the second printer acquired from a server; and
controlling a display unit to display the acquired icon images of the first and the second printers.

2. The computer readable storage medium according to claim 1, further comprising controlling the display unit to display a print setting screen for setting print settings to be transmitted to the first printer without interposing the server.

3. The computer readable storage medium according to claim 2, further comprising controlling the display unit to display a print setting screen for setting print settings to be transmitted to the second printer via the server.

4. The computer readable storage medium according to claim 2, wherein the print settings are provided to an operating system of an apparatus.

5. The computer readable storage medium according to claim 4, wherein the print settings are used to generate print data by a printer driver provided by a vendor of the operating system.

6. The computer readable storage medium according to claim 5, wherein the print data includes print settings defined by a predetermined protocol, and is transmitted to the first printer in conformance with the predetermined protocol.

7. The computer readable storage medium according to claim 6, wherein the predetermined protocol is Internet Printing Protocol.

8. An apparatus comprising:
at least one processor; and
a memory coupled to the at least one processor, the memory having instructions that, when executed by the processor, perform operations as:
an acquisition unit configured to acquire an icon image of a first printer based on identification information acquired from the first printer, and acquire an icon image of a second printer based on identification information for the second printer acquired from a server; and
a control unit configured to control a display unit to display the acquired icon images of the first and the second printers.

9. The apparatus according to claim 8, wherein the control unit further configured to control the display unit to display a print setting screen for setting print settings to be transmitted to the first printer without interposing the server.

10. The apparatus according to claim 9, further configured to control the display unit to display a print setting screen for setting print settings to be transmitted to the second printer via the server.

11. The apparatus according to claim 9, wherein the print settings are provided to an operating system of the apparatus.

12. The apparatus according to claim 11, wherein the print settings are used to generate print data by a printer driver provided by a vendor of the operating system.

13. The apparatus according to claim 12, wherein the print data includes print settings defined by a predetermined protocol, and is transmitted to the first printer in conformance with the predetermined protocol.

14. A method comprising:
acquiring an icon image of a first printer based on identification information acquired from the first printer;
acquiring an icon image of a second printer based on identification information for the second printer acquired from a server; and
controlling a display unit to display the acquired icon images of the first and the second printers.

15. The method according to claim 14, further comprising controlling the display unit to display a print setting screen for setting print settings to be transmitted to the first printer without interposing the server.

16. The method according to claim 15, further comprising controlling the display unit to display a print setting screen for setting print settings to be transmitted to the second printer via the server.

17. The method according to claim 15, wherein the print settings are provided to an operating system of an apparatus.

18. The method according to claim 17, wherein the print settings are used to generate print data by a printer driver provided by a vendor of the operating system.

19. The method according to claim 18, wherein the print data includes print settings defined by a predetermined protocol, and is transmitted to the first printer in conformance with the predetermined protocol.
